(19) United States
(12) Patent Application Publication
(10) Pub. No.: US 2006/0260654 A1
(43) Pub. Date: Nov. 23, 2006

(54) Method and apparatus for cleaning exterior condensers

(75) Inventor: David Lee Denney, Bedford, TX (US)

Correspondence Address: MICHAEL BEST & FRIEDRICH, LLP, 100 E WISCONSIN AVENUE, MILWAUKEE, WI, 53202, US

(73) Assignee: Hussmann Corporation, Bridgeton, MO (US)

(21) Appl. No.: 11/090,266

(22) Filed: Mar. 15, 2005

(51) Int. Cl. B08B 3/00; E01H 3/02

(52) U.S. Cl. 134/34; 239/172; 134/174; 134/198

(57) ABSTRACT

A method and apparatus for cleaning exterior condensers. The apparatus can include a vehicle, and a pump coupled to the vehicle and fluidly connected to a fluid source. The pump can move fluid from the fluid source to a fluid conduit. The fluid conduit can include a first and second end, and can be extendable to reach a location remote from the vehicle and adjacent the exterior condenser. The apparatus can further include a nozzle fluidly connected to the second end of the fluid conduit, and adapted to direct the fluid to clean the exterior condenser. The method can include moving the vehicle to a first location a distance from the exterior condenser, extending the fluid conduit to a second location positioned closer to the exterior condenser than the first location, moving fluid with the pump, and directing the fluid out of the nozzle to clean the exterior condenser.

### FIELD OF THE INVENTION

This invention relates to method and apparatus for cleaning exterior condensers. More particularly, this invention relates to a pressure washer and method for cleaning rooftop condensers.

### BACKGROUND OF THE INVENTION

Condensers include a coil assembly through which fluid (e.g., a refrigerant) is flown to exchange heat with the environment. Condensers, and particularly, exterior condensers can accumulate dirt and debris on the coil assembly, which can decrease the heat exchanging efficiency of the coil assembly. Thus, the coil assembly of the condensers needs to be periodically cleaned (e.g., as part of a preventive maintenance schedule) to maintain proper heat exchanging properties of the condensers.

Typically, exterior (e.g., rooftop) condensers are cleaned using a pump sprayer, cleaning chemicals, such as acid-base cleansers (e.g., a cleanser comprising glycolic acid and ammonium bisulfide, such as CAL-BRITE™ all-purpose cleanser, available from Nu-Calgon Wholesalers Inc.), and a water hose. The cleaning chemicals can create hazardous run-off water, leading to environmental concerns. In addition, the cleaning chemicals add unnecessary cost to the system. The chemicals need to be stored, logged and abated. Conventional cleaning systems include a high volume, low pressure washer (e.g., a water hose connected to a pump sprayer), or a high pressure, high volume washer (e.g., a pressure washer). Conventional high pressure, high volume washers run constantly and lack any automation to control when the pressure is turned on or off. In addition, conventional cleaning systems require that the low or high pressure washer be carried or otherwise moved to a location near the condenser to allow the coil assembly to be cleaned.

### SUMMARY OF THE INVENTION

Some embodiments of the present invention provide an apparatus for cleaning an exterior condenser. The apparatus can include a vehicle adapted to be moved from one location to another, and a pump coupled to the vehicle and fluidly connected to a fluid source. The pump can be adapted to pressurize fluid and move the pressurized fluid from the fluid source to a fluid conduit. The fluid conduit can include a first end in fluid communication with the pump and a second end. The fluid conduit can be extendable to reach a location remote from the vehicle and adjacent the exterior condenser. The apparatus can further include a nozzle fluidly connected to the second end of the fluid conduit. The nozzle can be adapted to direct the pressurized fluid to clean the exterior condenser.

In some embodiments of the present invention, a method for cleaning an exterior condenser is provided. The method can include providing a vehicle, a pump coupled to the vehicle and fluidly connected to a fluid source, and a fluid conduit fluidly connected to the pump and extendable to reach a remote location. The fluid conduit can include a first end in fluid communication with the pump, and a second end having a nozzle fluidly connected thereto. The method can further include moving the vehicle to a first location near the exterior condenser, and extending the fluid conduit to a second location positioned closer to the exterior condenser than the first location. The method can further include moving fluid with the pump from the fluid source, through the fluid conduit, and out the nozzle, and directing the fluid out of the nozzle to clean the exterior condenser.

Some embodiments of the present invention provide an apparatus for cleaning a coil assembly of an exterior condenser. The apparatus can include a vehicle adapted to move from a first location remote from the exterior condenser to a second location closer to the exterior condenser, and a pump coupled to the vehicle and fluidly connected to a fluid source. The fluid consists of water, and the pump can be adapted to pressurize the water and move the pressurized water from the fluid source through a fluid conduit. The fluid conduit can be coupled to the vehicle and can include a first end in fluid communication with the fluid source and a second end. The second end can be extendable from the first end to a third location positioned adjacent the exterior condenser. The apparatus can further include a nozzle fluidly coupled to the second end of the fluid conduit to direct the pressurized water to the exterior condenser to clean the coil assembly of the exterior condenser.

Other features and aspects of the invention will become apparent to those skilled in the art upon review of the following detailed description, claims, and drawings.

### BRIEF DESCRIPTION OF THE DRAWINGS

FIG. 1 is a side view of a condenser cleaning apparatus according to one embodiment of the present invention, and a condenser to be cleaned.

FIG. 2 is a rear perspective view of the condenser cleaning apparatus of FIG. 1, with the condenser removed for clarity.

FIG. 3 is close-up rear perspective view of the condenser cleaning apparatus of FIGS. 1 and 2, showing a pump and a fluid source, the fluid source including a reservoir.

FIG. 4 is close-up rear perspective view of the condenser cleaning apparatus of FIGS. 1-3, showing the pump.

FIG. 5 is a top perspective view of an opening in the reservoir of FIG. 3.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The terms “mounted,” “connected” and “coupled” are used broadly and encompass both direct and indirect mounting, connecting and coupling. Further, “connected” and “coupled” are not restricted to physical or mechanical connections or couplings. Furthermore, terms such as “front,” “rear,” “top,” “bottom,” and the like are only used to describe elements as they relate to one another, but are in no way meant to recite specific orientations of the apparatus, to indicate or imply necessary or required orientations of the apparatus, or to specify how the invention described herein will be used, mounted, displayed, or positioned in use.

### DETAILED DESCRIPTION

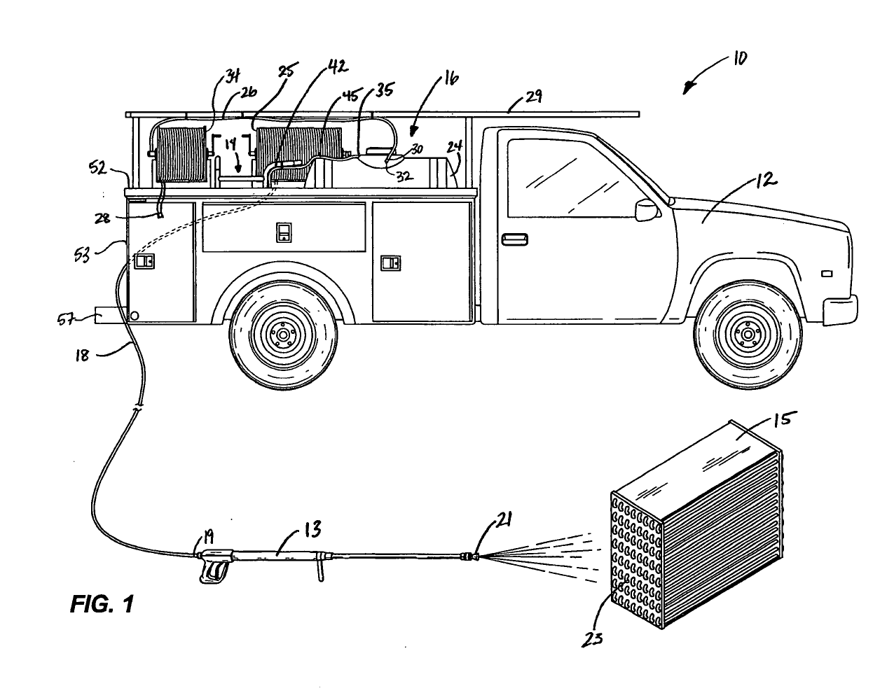

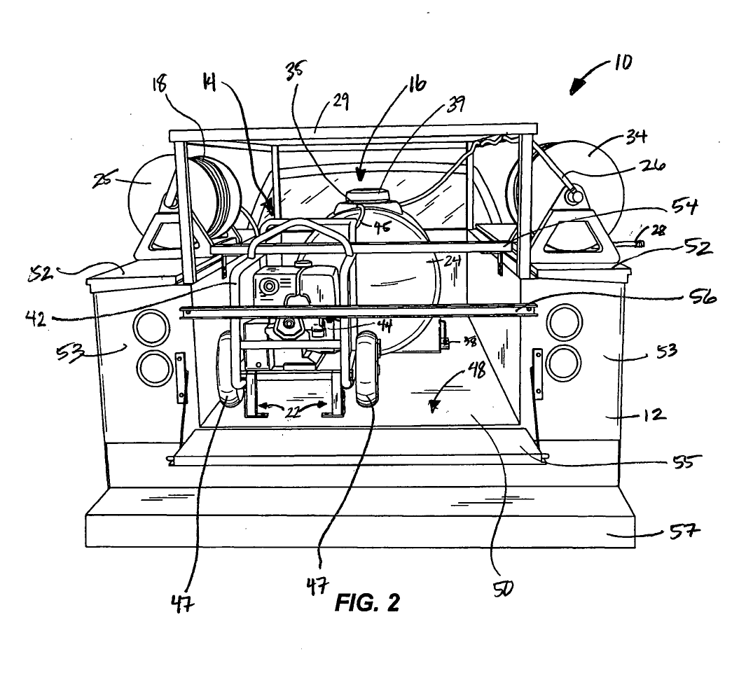

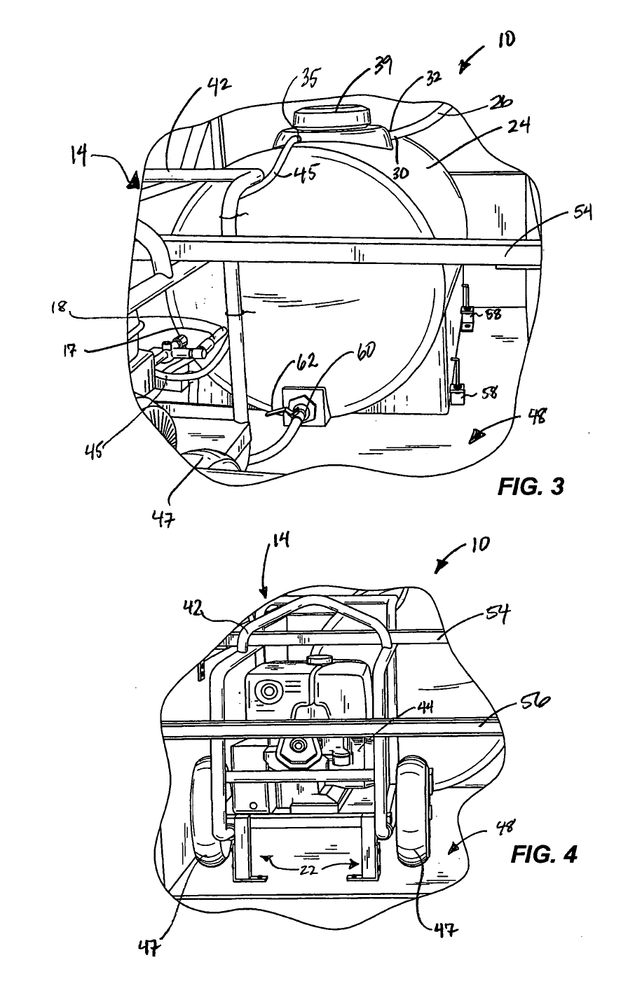

FIGS. 1-4 illustrate a condenser cleaning apparatus 10 according to one embodiment of the present invention, and an exterior condenser 15 to be cleaned. As shown in FIGS. 1 and 2, the condenser cleaning apparatus 10 can include a vehicle 12, a pump 14, a fluid source 16 fluidly coupled to the pump 14, and a first fluid conduit 18 (e.g., a hose wound around a first spool 25) fluidly coupled to the fluid source 16 to allow fluid to be moved by the pump 14 from the fluid source 16 to a location adjacent an exterior condenser 15. As shown in FIG. 3, the first fluid conduit 18 includes a first end 17 that is fluidly coupled to the pump 14, and, as shown in FIG. 1, a second end 19 that is fluidly coupled to a sprayer 13 having a nozzle 21. The nozzle 21 directs the fluid toward the exterior condenser 15, and particularly, to a coil assembly 23 of the exterior condenser 15. A variety of types of exterior condensers 15 can be cleaned using the present invention, including, without limitation, round-tube plate-fin condensers, evaporative condensers, fan-cooled condensers, and the like. In addition, the condenser cleaning apparatus 10 can be used to clean exterior condensers 15 at a variety of locations, including, without limitation, exterior condensers 15 positioned on the ground, on a rooftop, and the like.

In some embodiments, as shown in FIGS. 1-4, the fluid source 16 can include a reservoir 24 coupled to the vehicle 12 and adapted to contain the fluid, and a second fluid conduit 26 (e.g., a hose, as shown in FIGS. 1 and 2) for fluidly connecting the reservoir 24 to an external fluid source, such as city water. In some embodiments, the fluid contains only water to avoid the cost, inconvenience and environmental concerns of other cleaning chemicals or detergents. The second fluid conduit 26 includes a first end 28 to which the external fluid source can be coupled, and a second end 30 that is fluidly coupled to an inlet 32 of the reservoir 24. The second fluid conduit 26 has a length that can be wound around a second spool 34 to allow the second fluid conduit 26 to be extendable between an external fluid source at a location remote from the reservoir 24 and the inlet 32 of the reservoir 24. As shown in FIGS. 1 and 2, a portion of the second fluid conduit 26 can be secured to a frame 29 of the vehicle 12 to avoid cumbersome tangling of the second fluid conduit 26 with surrounding structures. The second fluid conduit 26 allows the reservoir 24 to be filled without removing the reservoir 24 from the vehicle 12. The reservoir 24 can be filled prior to use of the condenser cleaning apparatus 10, such that the condenser cleaning apparatus 10 can be transported to a location near the exterior condenser 15 to clean the exterior condenser 15, and does not need to be positioned near any external fluid source, or a connection to any external fluid source.

In some embodiments, the fluid source 16 does not include the reservoir 24, but instead includes an external fluid source to which the pump 14 can be fluidly coupled (via the second fluid conduit 26 or otherwise). In such embodiments, the fluid source 16 does not need to be coupled to the vehicle 12, but rather can be accessible at the location of the exterior condenser 15 to be cleaned (e.g., a connection to city water).

Whether the fluid source 16 includes a reservoir 24 or an external fluid source, the pump 14 is fluidly coupled to the fluid source 16, and pressurizes and moves the fluid from the fluid source 16 through the first fluid conduit 18 to the nozzle 21 to clean the exterior condenser 15. As shown in FIGS. 1-3, the pump 14 is fluidly coupled to an outlet 35 of the reservoir 24 by a third fluid conduit 45. In the illustrated embodiment, the outlet 35 is located in an upper portion of the reservoir 24, and the third fluid conduit 45 extends downwardly into the reservoir 24.

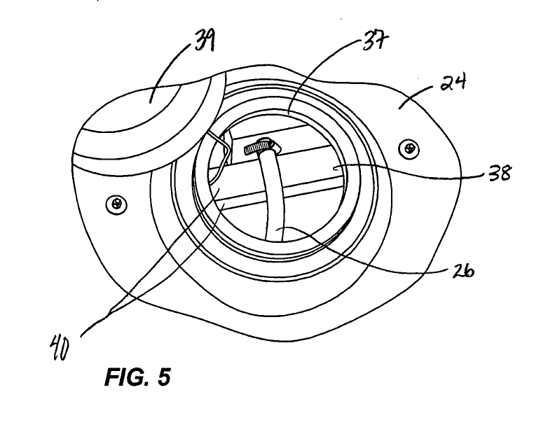

With reference to FIGS. 2-4, the pump 14 can include a frame 42 (or other supporting structure), and can be driven by an engine 44, as shown in FIGS. 2 and 4, an electric motor, and the like. Two wheels 47 are coupled to the frame 42 to allow the pump 14 to be easily transported. The pump 14 can include a variety of pumps that are capable of pressurizing and moving the fluid from the fluid source 16 through the first fluid conduit 18, including, without limitation, at least one of a positive displacement pump (e.g., a rotary pump), a centrifugal pump, and the like. For example, the pump 14 can include a pressure washer, such as a cold-water pressure washer (e.g., a BD series pressure washer, available from Hotsy, such as model no. BD0011H, which is capable of pressurizing the fluid to a pressure of about 3000 PSI at a flow rate of about 3.5 gallons per minute). The pump 14 can move the fluid at a variety of pressures and flow rates to clean the exterior condenser 15, including, without limitation, a pressure of at least about 2500 PSI, and a flow rate of at least about 3.0 gallons per minute. In some embodiments, the pump 14 moves the fluid at a flow rate of at least about 4.4 gallons per minute.

As shown in FIGS. 2-4, the vehicle 12 includes a support surface 48. Various components of the condenser cleaning apparatus 10 can be coupled to the support surface 48. In some embodiments, coupling the components to the support surface 48 includes positioning the components on the support surface 48, and in some embodiments, coupling the components to the support surface 48 includes securing them to the support surface 48. For example, in the embodiment shown in FIGS. 1-4, the vehicle 12 includes a pick-up truck, and the support surface 48 can include a variety of surfaces on the truck, including a truck bed 50 of the pick-up truck, two side platforms 52, and two rear walls 53 to which various components of the condenser cleaning apparatus 10 can be secured. The truck also includes a rear door 55, and a rear platform 57. Accordingly, the support surface 48 can further include the rear door 55, the rear platform 57, and the frame 29. The rear door 55 is pivotally coupled to a rear portion of the truck to allow the rear door 55 to be pivoted downwardly to allow access to the truck bed 50.

In the embodiment illustrated in FIGS. 2-4, a bottom portion of the frame 42 of the pump 14 is secured to the support surface 48 by a plurality of brackets 22 that are bolted to the truck bed 50. An upper portion of the frame 42 of the pump 14 is secured to the vehicle by a first lateral brace 54 that is bolted to each of the side platforms 52. A forward portion of the frame 42 of the pump 14 is secured to the vehicle 12 by a second lateral brace 56 that is bolted to each of the rear walls 53. The brackets 22 and the first and second lateral braces 54 and 56 substantially maintain the pump 14 in position and substantially avoid movement of the pump 14 while the vehicle 12 is in motion. The brackets 22 and the first and second lateral braces 54 and 56 also substantially prevent theft of the pump 14.

As shown in FIGS. 2-3, the reservoir 24 is secured to the support surface 48 by a plurality of brackets 58 that are bolted to the truck bed 50. In addition, the first spool 25 and the second spool 34 around which the first fluid conduit 18 and the second fluid conduit 26 are wound, respectively, are each secured to a side platform 52 with bolts.

While specific brackets, braces and bolts are described above with respect to the illustrated embodiment, it should be understood that the components of the condenser cleaning apparatus 10 can be secured to the support surface 48 by a variety of fasteners, including, without limitation, at least one of nails, screws, bolts, adhesives, magnets, welding, snap-fit-type engagement, straps, and the like.

In the embodiment shown in FIGS. 1-4, the vehicle 12 includes a pick-up truck. However, the vehicle 12 can include a variety of other vehicle types, including, without limitation, a trailer that can be pulled by another type of vehicle, a car, a van, and any other vehicle known to those of ordinary skill in the art capable of transporting the pump 14, the fluid source 16 (in some embodiments), and the first fluid conduit 18 to a position closer to the exterior condenser 15.

In some embodiments, filling of the reservoir 24 is performed manually. In some embodiments, filling of the reservoir 24 is automatically controlled. For example, filling of the reservoir 16 can be controlled by a valve adjacent the inlet 32 of the reservoir 24. The valve can be automatically actuated by a float assembly. The float assembly can include a ball float that floats atop the surface of the fluid in the reservoir 24. When the fluid level in the reservoir 24 drops below a desired level, the ball float is dropped, actuating the valve to open to allow fluid to flow into the inlet 32 of the reservoir 24. The ball float will rise with the fluid level as fluid fills the reservoir 24. When the ball float reaches a desired level, it actuates the valve to close to cease filling of the reservoir 24. As shown in FIG. 3, the reservoir 24 can be drained (e.g., manually) via a drain outlet 60 of the reservoir 24 that can be opened or closed via a valve that is controlled by a lever 62.

FIG. 5 illustrates a top view of an opening 37 in an upper portion of the reservoir 24. The opening 37 allows access to the interior of the reservoir 24, and can be used to manually fill or remove fluid from the reservoir 24. The opening 37 can be covered with a cap 39, which has been removed in FIG. 5 to allow visualization of the interior of the reservoir 24. In some embodiments, as shown in FIG. 5, a baffle 38 is positioned in the reservoir 24 to at least partially cover the float assembly 36, such that sloshing of the fluid adjacent the float assembly is inhibited to inhibit unnecessary triggering of the float assembly-actuated valve. The baffle 38 shown in FIG. 5 includes three walls 40, each wall 40 oriented at a 90-degree angle with respect to an adjacent wall 40 to form a three-sided structure that at least partially divides the reservoir 24 into separate fluid compartments. The walls 40 of the baffle 38 define an inner chamber within the baffle 38 within which the float assembly is positioned to substantially isolate the ball float of the float assembly from the remainder of the fluid in the reservoir 24. As shown in FIG. 5, an upper wall 40 of the baffle 38 is bolted to an upper portion of the reservoir 24. It should be understood, however, that the baffle 38 can be secured to the reservoir 24 by any of the securing means described above, or can be integrally formed with the reservoir 24.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. An apparatus for cleaning an exterior condenser, the apparatus comprising:
a vehicle adapted to be moved from one location to another;
a pump coupled to the vehicle and fluidly connected to a fluid source, the pump adapted to pressurize fluid and move the pressurized fluid from the fluid source to a fluid conduit, the fluid conduit having a first end in fluid communication with the pump and a second end, the fluid conduit being extendable to reach a location remote from the vehicle and adjacent the exterior condenser; and
a nozzle fluidly connected to the second end of the fluid conduit, the nozzle adapted to direct the pressurized fluid to clean the exterior condenser.

2. The apparatus of claim 1, wherein the pump includes a pressure washer.

3. The apparatus of claim 1, wherein the fluid conduit includes a hose that is wound around a spool, the spool being coupled to the vehicle.

4. The apparatus of claim 1, wherein the pump is secured to a support surface of the vehicle to inhibit movement of the pump relative to the support surface.

5. The apparatus of claim 1, wherein the fluid source includes a reservoir, and wherein the reservoir includes a float assembly positioned to automatically control filling of the reservoir.

6. The apparatus of claim 5, further comprising a baffle positioned adjacent an upper portion of the reservoir to at least partially cover the float assembly.

7. The apparatus of claim 1, wherein the fluid consists of water.

8. The apparatus of claim 1, wherein the pump moves about 3.5 gallons of fluid per minute.

9. The apparatus of claim 1, wherein the pump pressurizes the fluid to about 3000 PSI.

10. A method for cleaning an exterior condenser, the method comprising:
providing a vehicle, a pump coupled to the vehicle and fluidly connected to a fluid source, and a fluid conduit fluidly connected to the pump and extendable to reach a remote location, the fluid conduit having a first end in fluid communication with the pump, and a second end having a nozzle fluidly connected thereto;
moving the vehicle to a first location a distance from the exterior condenser;
extending the fluid conduit to a second location positioned closer to the exterior condenser than the first location;
moving fluid with the pump from the fluid source, through the fluid conduit, and out the nozzle; and
directing the fluid out of the nozzle to clean the exterior condenser.

11. The method of claim 10, wherein the fluid consists of water.

12. The method of claim 10, wherein the fluid conduit includes a hose, wherein the hose is wound around a spool coupled to the vehicle, and wherein extending the fluid conduit to a second location includes unwinding the hose from the spool.

13. The method of claim 10, further comprising securing the pump to the vehicle.

14. The method of claim 10, wherein the fluid source includes a reservoir that is coupled to the vehicle, and a second fluid conduit coupled to the vehicle and in fluid communication with the reservoir, and further comprising filling the reservoir via the second fluid conduit.

15. The method of claim 14, wherein the reservoir includes a float assembly, and further comprising automatically controlling filling of the reservoir with the float assembly.

16. The method of claim 10, further comprising:
providing a baffle to at least partially cover the float assembly; and
inhibiting sloshing of fluid adjacent the float assembly in the reservoir with the baffle.

17. The method of claim 10, wherein moving fluid with the pump includes moving the fluid at a flow rate of about 3.5 gallons per minute and a pressure of about 3000 PSI.

18. An apparatus for cleaning a coil assembly of an exterior condenser, the apparatus comprising:
a vehicle adapted to move from a first location remote from the exterior condenser to a second location closer to the exterior condenser;
a pump coupled to the vehicle and fluidly connected to a fluid source, wherein the fluid consists of water, the pump adapted to pressurize the water and move the pressurized water from the fluid source through a fluid conduit, the fluid conduit being coupled to the vehicle and having a first end in fluid communication with the fluid source and a second end, the second end being extendable from the first end to a third location positioned adjacent the exterior condenser; and
a nozzle fluidly coupled to the second end of the fluid conduit to direct the pressurized water to the exterior condenser to clean the coil assembly of the exterior condenser.
